(19) United States
(12) Patent Application Publication
(10) Pub. No.: US 2025/0004234 A1
(43) Pub. Date: Jan. 2, 2025

(54) FIBER OPTIC ENCLOSURE WITH INTERNAL CABLE SPOOL

(71) Applicant: CommScope Technologies LLC, Hickory, NC (US)

(72) Inventors: Scott C. Kowalczyk, Savage, MN (US); Jonathan Walter Coan, Mayer, MN (US); Jonathan R. Kaml, Shakopee, MN (US)

(21) Appl. No.: 18/674,528

(22) Filed: May 24, 2024

Related U.S. Application Data
(63) Continuation of application No. 18/164,815, filed on Feb. 6, 2023, now Pat. No. 12,019,301.
Application No. 18/164,815 is a continuation of application No. 17/238,375, filed on Apr. 23, 2021, now Pat. No. 11,573,390.
Application No. 17/238,375 is a continuation of application No. 15/875,564, filed on Jan. 19, 2018, now Pat. No. 10,996,417.
Application No. 15/875,564 is a continuation of application No. 15/470,311, filed on Mar. 27, 2017, now Pat. No. 10,712,518.
Application No. 15/470,311 is a continuation of application No. 14/979,870, filed on Dec. 28, 2015, now Pat. No. 9,606,319.
Application No. 14/979,870 is a continuation of application No. 14/539,459, filed on Nov. 12, 2014, now Pat. No. 9,261,666.
Application No. 14/539,459 is a continuation of application No. 14/132,691, filed on Dec. 18, 2013, now Pat. No. 8,891,931.
Application No. 14/132,691 is a continuation of application No. 13/924,191, filed on Jun. 21, 2013, now Pat. No. 8,705,929.
Application No. 13/924,191 is a continuation of application No. 13/479,015, filed on May 23, 2012, now Pat. No. 8,494,333.
Application No. 13/479,015 is a continuation of application No. 13/032,337, filed on Feb. 22, 2011, now Pat. No. 8,189,984.
Application No. 13/032,337 is a continuation of application No. 12/793,556, filed on Jun. 3, 2010, now Pat. No. 7,894,701.
Application No. 12/793,556 is a continuation of application No. 12/182,705, filed on Jul. 30, 2008, now Pat. No. 7,756,379.
(60) Provisional application No. 61/029,248, filed on Feb. 15, 2008.
(60) Provisional application No. 60/954,214, filed on Aug. 6, 2007.

(51) Int. Cl. G02B 6/44; G02B 6/38; G02B 6/46

(52) U.S. Cl. CPC G02B 6/4457; G02B 6/3897; G02B 6/4441; G02B 6/4446; G02B 6/445; G02B 6/4452; G02B 6/4453; G02B 6/4454; G02B 6/4471; G02B 6/46

(57) ABSTRACT

A fiber optic enclosure assembly includes a housing having an interior region and a bearing mount disposed in the interior region of the housing. A cable spool is connectedly engaged with the bearing mount such that the cable spool selectively rotates within the housing. A termination module disposed on the cable spool so that the termination module rotates in unison with the cable spool. A method of paying out a fiber optic cable from a fiber optic enclosure includes rotating a cable spool, which has a subscriber cable coiled around a spooling portion of the cable spool, about an axis of a housing of the fiber optic enclosure until a desired length of subscriber cable is paid out. A termination module is disposed on the cable spool.

### CROSS-REFERENCE TO RELATED APPLICATIONS

This application is a continuation of application Ser. No. 18/164,815, filed Feb. 6, 2023, which is a continuation of application Ser. No. 17/238,375, filed Apr. 23, 2021, now U.S. Pat. No. 11,573,390, which is a continuation of application of Ser. No. 15/875,564, filed Jan. 19, 2018, now U.S. Pat. No. 10,996,417, which is a continuation of application Ser. No. 15/470,311, filed Mar. 27, 2017, now U.S. Pat. No. 10,712,518, which is a continuation of application Ser. No. 14/979,870, filed Dec. 28, 2015, now U.S. Pat. No. 9,606,319, which is a continuation of application Ser. No. 14/539,459, filed Nov. 12, 2014, now U.S. Pat. No. 9,261,666, which is a continuation of application Ser. No. 14/132,691, filed Dec. 18, 2013, now U.S. Pat. No. 8,891,931, which is a continuation of application Ser. No. 13/924,191, filed Jun. 21, 2013, now U.S. Pat. No. 8,705,929, which is a continuation of application Ser. No. 13/479,015, filed May 23, 2012, now U.S. Pat. No. 8,494,333, which is a continuation of application Ser. No. 13/032,337, filed Feb. 22, 2011, now U.S. Pat. No. 8,189,984, which is a continuation of application Ser. No. 12/793,556, filed Jun. 3, 2010, now U.S. Pat. No. 7,894,701, which is a continuation of application Ser. No. 12/182,705, filed Jul. 30, 2008, now U.S. Pat. No. 7,756,379, which application claims the benefit of provisional application Ser. No. 61/029,248, filed Feb. 15, 2008 and 60/954,214, filed Aug. 6, 2007, which applications are incorporated herein by reference in their entirety.

### TECHNICAL FIELD

The present disclosure relates to fiber optic enclosure, and more particularly, to a fiber optic enclosure with cable payout.

### BACKGROUND

As demand for telecommunications increases, fiber optic networks are being extended in more and more areas. In facilities such as multiple dwelling units, apartments, condominiums, businesses, etc., fiber optic enclosures are used to provide a subscriber access point to the fiber optic network. These fiber optic enclosures are connected to the fiber optic network through subscriber cables connected to a network hub. However, the length of subscriber cable needed between the fiber optic enclosure and the network hub varies depending upon the location of the fiber optic enclosure with respect to the network hub. As a result, there is a need for a fiber optic enclosure that can effectively manage varying lengths of subscriber cable.

### SUMMARY

An aspect of the present disclosure relates to a fiber optic enclosure assembly for enclosing optical fiber connections. The fiber optic enclosure assembly includes a housing having an interior region and a bearing mount disposed in the interior region of the housing. A cable spool is connectedly engaged with the bearing mount such that the cable spool selectively rotates within the housing. A termination module is disposed on the cable spool so that the termination module rotates in unison with the cable spool.

Another aspect of the present disclosure relates to a method of paying out a fiber optic cable from a fiber optic enclosure. The method includes rotating a cable spool, which has a subscriber cable coiled around a spooling portion of the cable spool, about an axis of a housing of the fiber optic enclosure until a desired length of subscriber cable is paid out. The cable spool is disposed in an interior region of the fiber optic enclosure and a termination module is disposed on the cable spool.

A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### DESCRIPTION OF THE DRAWINGS

FIG. 1 is a schematic representation of a fiber optic network that includes a fiber optic enclosure having features that are examples of inventive aspects in accordance with the principles of the present disclosure.

FIG. 2 is an isometric view of the fiber optic enclosure of FIG. 1.

FIG. 3 is an isometric view of the fiber optic enclosure of FIG. 2 with a cover in an open position.

FIG. 4 is a front view of the fiber optic enclosure of FIG. 2 with the cover in the open position.

FIG. 5 is an exploded isometric view of the fiber optic enclosure of FIG. 2.

FIG. 6 is a perspective view of a fiber optic adapter suitable for use within the fiber optic enclosure of FIG. 2.

FIG. 7 is a cross-sectional view of the fiber optic adapter taken on line 7-7 of FIG. 6.

FIG. 8 is an isometric view of another embodiment of a fiber optic enclosure.

FIG. 9 is a front view of the fiber optic enclosure of FIG. 8.

FIG. 10 is a top view of the fiber optic enclosure of FIG. 8.

FIG. 11 is a side view of the fiber optic enclosure of FIG. 8.

FIG. 12 is an isometric view of the fiber optic enclosure of FIG. 8, showing cables entering and exiting the enclosure.

FIG. 13 is an isometric view of the fiber optic enclosure of FIG. 12 without the cover.

FIG. 14 is a front view of the fiber optic enclosure of FIG. 13.

FIG. 15 is an exploded isometric view of the fiber optic enclosure of FIG. 13.

FIG. 16 is an isometric view of the cable spool of the fiber optic enclosure of FIG. 13.

FIG. 17 is a further isometric view of the fiber optic enclosure of FIG. 12, with the cover in the pivoted open position.

FIG. 18 is an exploded view of a shipping container in which is disposed the fiber optic enclosure of FIG. 8.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

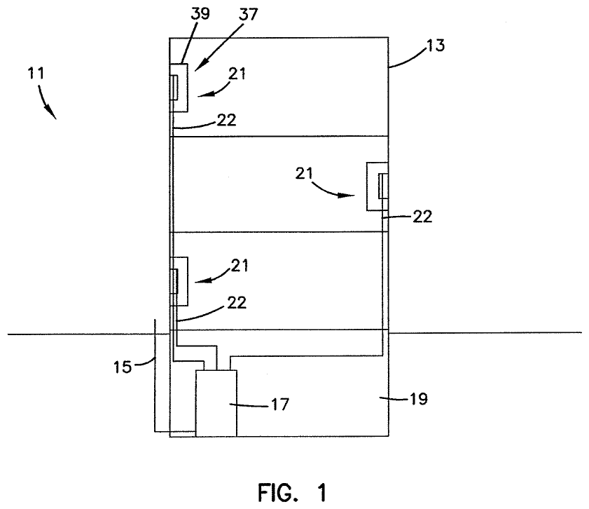

Referring now to FIG. 1, a schematic representation of a fiber optic network, generally designated 11, in a facility 13 (e.g. individual residence, apartment, condominium, business, etc.) is shown. The fiber optic network 11 includes a feeder cable 15 from a central office (not shown). The feeder cable 15 enters a feeder cable input location 17 (e.g., a fiber distribution hub, a network interface device, etc.) having one or more optical splitters (e.g., 1-to-8 splitters, 1-to-16 splitters, or 1-to-32 splitters) that generate a number of individual fibers. In the subject embodiment, and by way of example only, the fiber distribution hub 17 is located on a lower level 19 of the facility 13. Each unit in the facility 13 includes a fiber optic enclosure, generally designated 21, with a subscriber cable 22 extending from each of the fiber optic enclosures 21 to the fiber distribution hub 17. The subscriber cable 22 extending between the fiber distribution hub 17 and the fiber optic enclosure 21 typically includes multiple optical fibers.

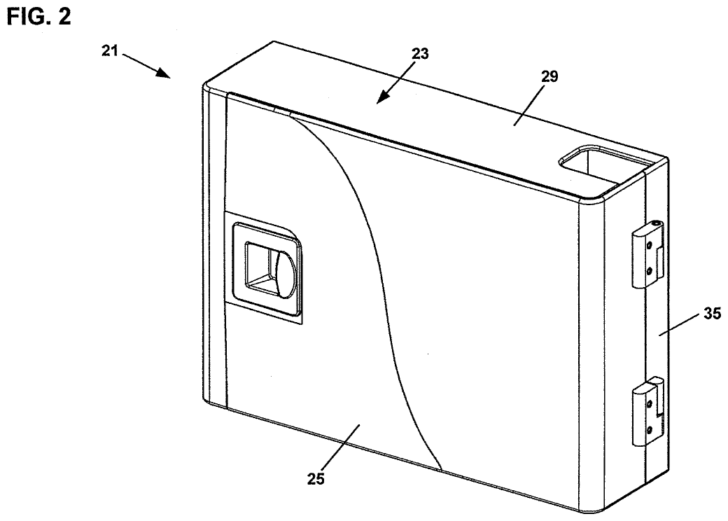

Referring now to FIGS. 2-5, the fiber optic enclosure 21 will now be described. The fiber optic enclosure 21 includes a housing, generally designated 23, having a cover 25.

The housing 23 includes a base 27, a first sidewall 29, and an oppositely disposed second sidewall 31. The first and second sidewalls 29, 31 extend outwardly from the base 27 such that the base 27 and the first and second sidewalls 29, 31 cooperatively define an interior region 33. In the subject embodiment, the cover 25 is hingedly engaged with a sidewall 35 that is connected to the base 27 and the first and second sidewalls 29, 31. It will be understood, however, that the scope of the present disclosure is not limited to the cover 25 being hingedly engaged the sidewall 35.

A cable spool, generally designated 37, is disposed in the interior region 33 of the fiber optic enclosure 21. The cable spool 37 includes a spooling portion 39, around which subscriber cable 22 is coiled (shown schematically in FIG. 1). The cable spool 37 further includes an axial end 41.

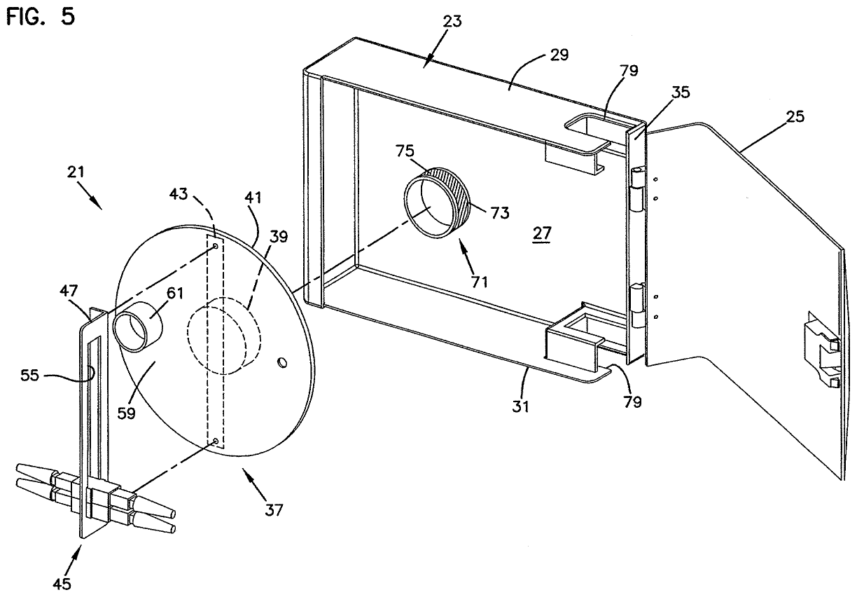

In the subject embodiment, the axial end 41 of the cable spool 37 defines a termination area 43 (shown as a dashed line in FIG. 5). Disposed in the termination area 43 is a termination module, generally designated 45. The termination module 45 of the fiber optic enclosure 21 serves as the dividing line between the incoming fibers and the outgoing fibers.

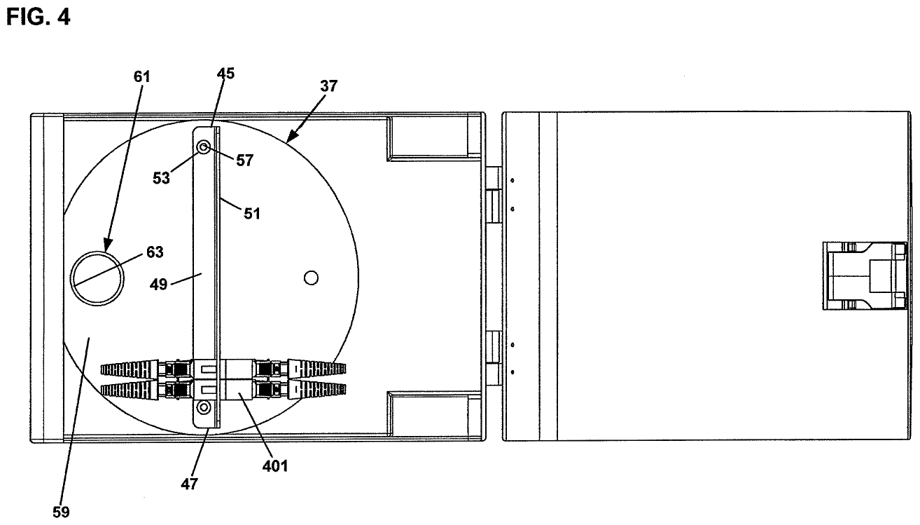

In the subject embodiment, the termination module 45 includes an adapter plate 47. The adapter plate 47 is an L-shaped bracket having a first side 49 (shown in FIG. 4) and a second side 51. The first side 49 defines a plurality of mounting holes 53 while the second side 51 defines an adapter slot 55. It will be understood, however, that the scope of the present disclosure is not limited to the adapter plate 47 being an L-shaped bracket. The first side 49 of the adapter plate 47 is rigidly mounted (i.e., non-rotatable) to the axial end 41 of the cable spool 37 through a plurality of fasteners 57 (e.g., bolts, screws, rivets, etc.) which are inserted through the mounting holes 53 in the first side 49 and in connected engagement with the axial end 41 of the cable spool 37.

The adapter slot 55 in the second side 51 of the adapter plate 47 is adapted to receive a plurality of adapters, generally designated 401. In the subject embodiment, the adapters 401 are SC-type adapters 401, although it will be understood that the scope of the present disclosure is not limited to the use of SC-type adapters 401. Similar SC-type adapters 401 have been described in detail in commonly owned U.S. Pat. No. 5,317,663, the disclosure of which is incorporated herein by reference.

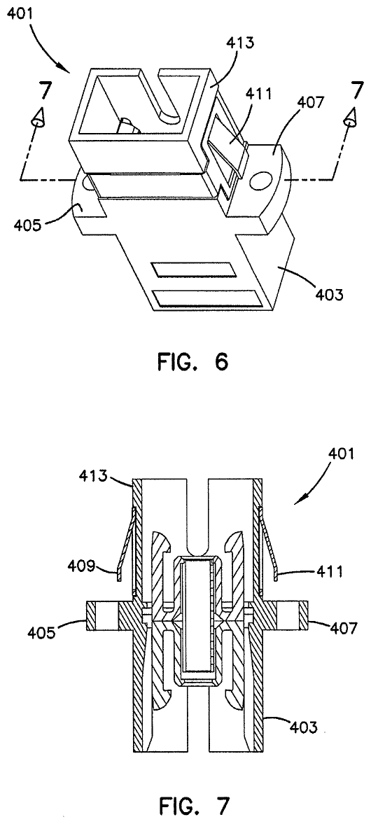

Referring now to FIGS. 6 and 7, the SC-type adapter 401 includes a main body 403 with a pair of tabs 405, 407 located on the exterior of the main body 403. The tabs 405, 407 serve to support the adapter 401 in the adapter slot 55. The adapter 401 further includes a pair of retaining clips 409, 411, with one retaining clip 409, 411 associated with each tab 405, 407. A front side 413 of the adapter 401 is inserted into the adapter slot 55. As the adapter 401 is inserted through the adapter slot 55, the retaining clips 409, 411 compress against the main body 403. The adapter 401 is inserted into the adapter slot 55 until the tabs 405, 407 abut the adapter plate 47. With the tabs 405, 407 abutting the adapter plate 47, the retaining clips 409, 411 decompress on the opposite side of the adapter plate 47, thereby retaining the adapter plate 47 between the retaining clips 409, 411 and the tabs 405, 407.

In an alternate embodiment, the termination module includes a plurality of sliding adapter modules. Similar sliding adapter modules have been described in detail in commonly owned U.S. Pat. Nos. 5,497,444; 5,717,810, 6,591,051 and U.S. Pat. Pub. No. 2007/0025675, the disclosures of which are incorporated herein by reference.

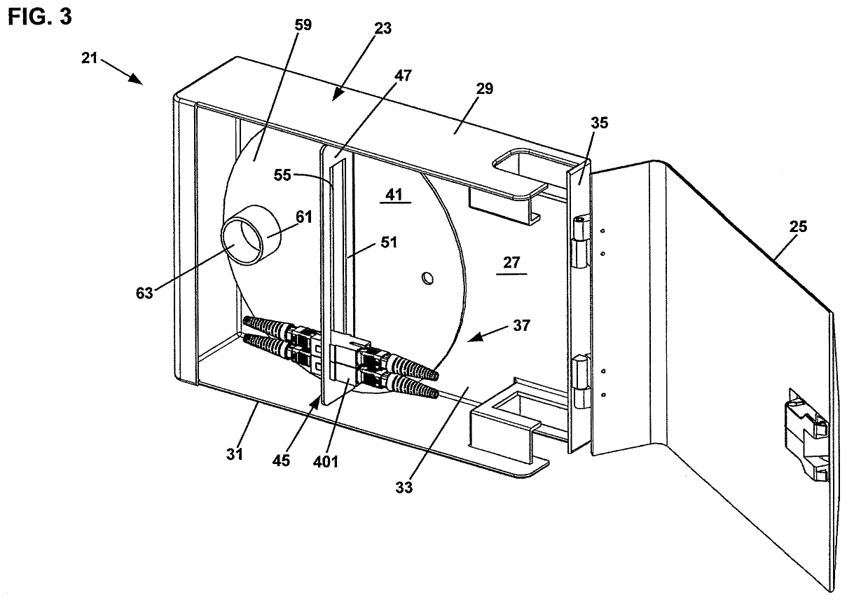

Referring now to FIGS. 3-5, the axial end 41 of the cable spool 37 further defines a slack storage area 59. The slack storage area 59 includes a cable management spool 61 disposed on the axial end 41 of the cable spool 37. The cable management spool 61 is sized such that an outer radius of the cable management spool 61 is larger than the minimum bend radius of the optical fibers so as to avoid attenuation damage to the optical fibers during storage.

The cable management spool 61 and the axial end 41 of the cable spool 37 cooperatively define a cable passage 63 that extends axially through the cable management spool 61 and through the axial end 41 of the cable spool 37. The cable passage 63 allows connectorized ends of incoming optical fibers to pass from the spooling portion 39 of the cable spool 37 to the slack storage area 59. The connectorized ends of the incoming optical fibers are then routed from the slack storage area 59 to the front sides 413 of the adapters 401 in the termination area 43.

Referring now to FIG. 5, the fiber optic enclosure 21 further includes a bearing mount, generally designated 71. In the subject embodiment, the bearing mount 71 is disposed on the base 27 of the housing 23. An outer surface 73 of the bearing mount 71 is adapted for a bearing 75 (shown as cross-hatching). In the subject embodiment, the bearing 75 is a needle bearing. However, it will be understood that the scope of the present disclosure is not limited to the bearing 75 being a needle bearing as the bearing 75 could also include a bushing, low-friction coating, etc.

In one embodiment, the bearing 75 is engaged with an inner diameter of a central hole of the cable spool 37. In another embodiment, a rotary plain bearing is formed between the outer surface 73 of the bearing mount 71 and the inner diameter of the central hole of the cable spool 37. In this embodiment, the outer diameter of the bearing mount 71 is sized to fit within an inner diameter of a central hole of the spooling portion 39. The engagement of the bearing mount 71 and the spooling portion 39 of the cable spool 37 allows the cable spool 37 to rotate about the central axis 77 of the bearing mount 71.

Referring now to FIGS. 1 and 5, the subscriber cable 22, which includes multiple optical fibers, is coiled around the spooling portion 39 of the cable spool 37. In order to protect the subscriber cable 22 from attenuation resulting from the coiling of the subscriber cable 22 around the spooling portion 39, the cable spool 37 has an outer circumferential surface having a radius that is greater than the minimum bend radius of the subscriber cable 22. The subscriber cable 22 includes a first end having connectorized ends, which are inserted through the cable passage 63 and connectedly engaged with the first ends 413 of the adapters 401. A second end of the subscriber cable 22 is configured for connectivity with the fiber distribution hub 17. However, as shown in FIG. 1, the length of subscriber cable 22 needed between each of the fiber optic enclosures 21 in the facility 13 and the fiber distribution hub 17 will vary depending upon the location of each fiber optic enclosure 21 with respect to the fiber distribution hub 17.

A method of installing and using the fiber optic enclosure 21 to account for the varying lengths of subscriber cable 22 needed between the fiber optic enclosure 21 and the fiber distribution hub 17 will now be described. The fiber optic enclosure 21 provides dual functionality by serving as a storage location for the subscriber cable 22 and by selectively paying out a desired length of the subscriber cable 22.

A first length of subscriber cable 22 is stored in the fiber optic enclosure 21 by coiling the length of subscriber cable 22 around the cable spool 37. The first length of subscriber cable 22 includes an installation length, which is sufficiently long to extend from the mounting location of the enclosure 28 to the fiber distribution hub 17, and an excess length, which is the length of subscriber cable 22 remaining on the cable spool 37 after the installation length has been paid out. In one embodiment, the first length is greater than or equal to about 100 feet. In another embodiment, the first length of subscriber cable 22 is greater than or equal to about 200 feet. In another embodiment, the first length of subscriber cable 22 is greater than or equal to about 300 feet. In another embodiment, the first length of subscriber cable 22 is greater than or equal to about 400 feet. In another embodiment, the first length of subscriber cable 22 is greater than or equal to about 500 feet. In another embodiment, the first length of subscriber cable 22 is in the range of about 100 to about 2,000 feet. In another embodiment, the first length of subscriber cable 22 is in the range of about 100 to about 1,500 feet. In another embodiment, the first length of subscriber cable 22 is in the range of about 500 to about 1,500 feet. In a preferred embodiment, the first length of subscriber cable 22, which is coiled around the cable spool 89, is in the range of 100 to 500 feet.

In one embodiment, a second length, or the excess length, of subscriber cable 22 is stored around the cable spool 37 after the first length of subscriber cable 22 has been paid out. If the first length of subscriber cable 22 is greater than the installation length of subscriber cable 22, the second length, or excess length, is stored around the cable spool 37.

The second function of the fiber optic enclosure 21 involves the selective payout of the subscriber cable 22. With the cable spool 37 mounted to the bearing mount 71, the first end of the subscriber cable 22 in connected engagement with the front sides 413 of the adapters 401 and the outgoing optical fibers disengaged from the back sides of the adapters 401, the subscriber cable 22 can be paid out through fiber ports 79 disposed in the first and second sidewalls 29, 31. The subscriber cable 22 is paid out of the fiber optic enclosure 21 by selectively rotating the cable spool 37 with respect to the housing 23 about the central axis 77 of the bearing mount 71. As the termination module 45 is disposed on the axial end 41 of the cable spool 37, the selective rotation of the cable spool 37 with respect to the housing 23 results in the selective rotation of the termination module 45. Since the termination module 45 rotates unitarily with or in unison with the cable spool 37, the second end of the subscriber cable 22 can be paid out without the first end of the subscriber cable 22 being pulled out of the termination module 45.

Once the desired length of subscriber cable 22 has been paid out, the rotation of the cable spool 37 is ceased. At this point, the position of the cable spool 37 can be fixed such that it does not rotate relative to the housing 23. In one embodiment, a pin is inserted through an opening in the axial end 41 of the cable spool 37 and through a corresponding opening in the base 27 of the housing 23 to fix the position of the cable spool 37 with respect to the housing 23. It will be understood, however, that the scope of the present disclosure is not limited to the use of a pin to fix the position of the cable spool 37 with respect to housing 23.

An alternate method of selectively paying-out subscriber cable 22 from the fiber optic enclosure 21 will now be described. With the fiber optic enclosure 21 positioned near the fiber distribution hub 17, the second end of the subscriber cable 22 is unwound from the cable spool 37. In one embodiment, the second end is optically connected to the fiber distribution hub 17. With the second end of the subscriber cable 22 optically connected to the fiber distribution hub 17 and the first end of the subscriber cable 22 in connected engagement with the termination module 45, the fiber optic enclosure 21 is transported away from the fiber distribution hub 17. In one embodiment, the fiber optic enclosure 21 is carried away from the fiber distribution hub 17 by an installer. In another embodiment, the fiber optic enclosure 21 is transported away from the fiber distribution hub 17 in a wheeled cart (e.g., dolly, 4-wheeled cart, etc.). In a preferred embodiment, the fiber optic enclosure is disposed in a packaging enclosure (e.g., a box) during transport. As the fiber optic enclosure 21 is transported away from the fiber distribution hub 17, the subscriber cable 22 unwinds from the cable spool 37 causing the cable spool 37 to rotate within the interior region 33 of the housing 23, which is disposed in the packaging enclosure. When the fiber optic enclosure 21 has been transported to its mounting location, the fiber optic enclosure 21 is removed from the packaging enclosure, mounted to the mounting location. The cable spool 37 can be fixed in position relative to the housing 23 to prevent inadvertent rotation of the cable spool 37.

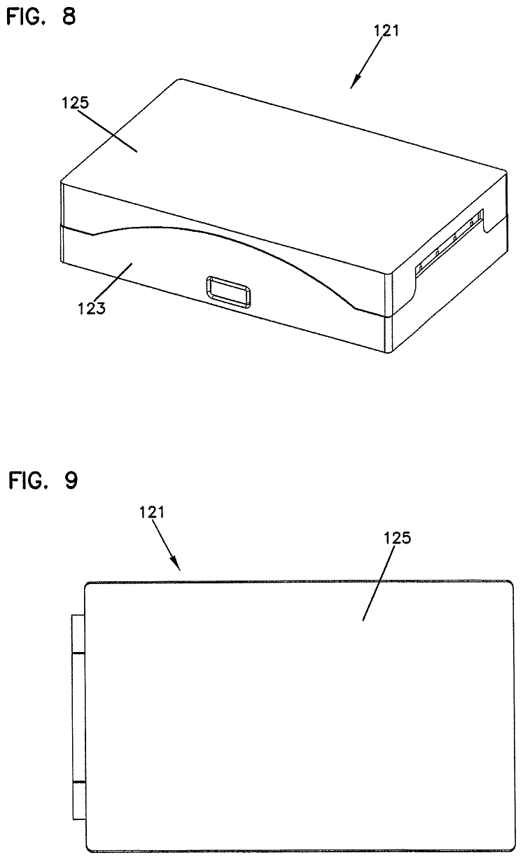

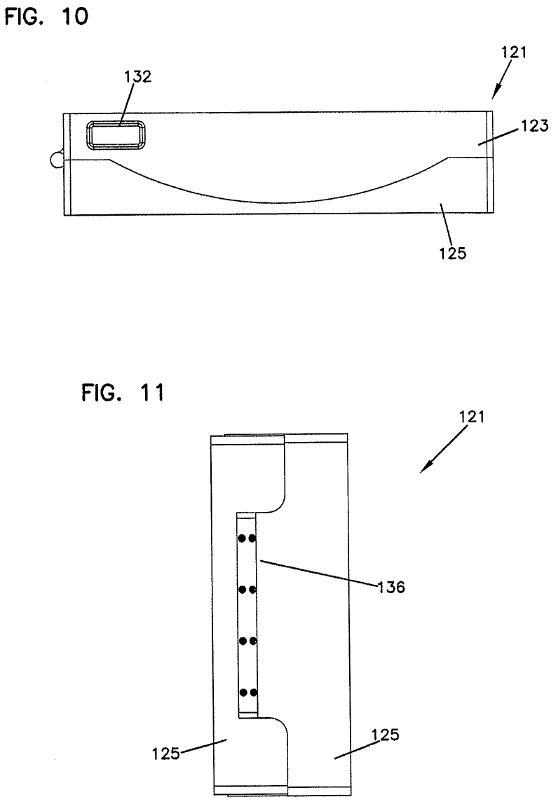

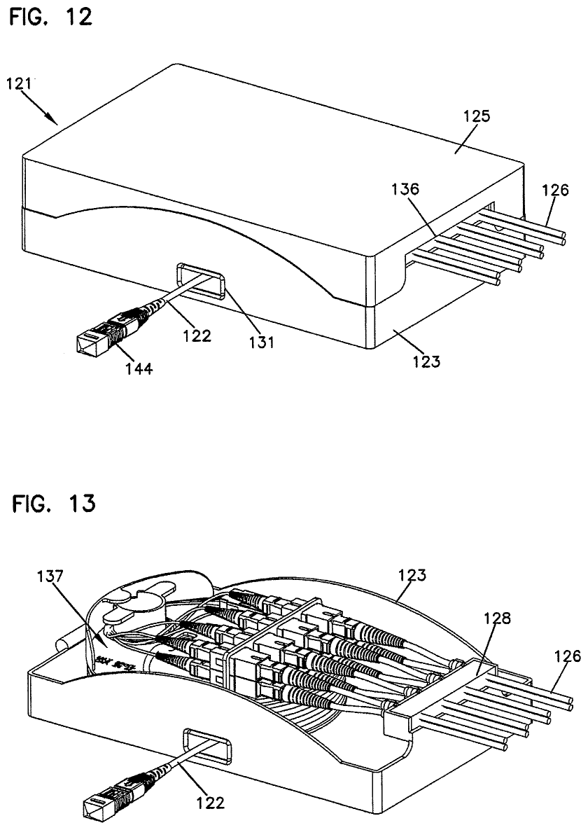

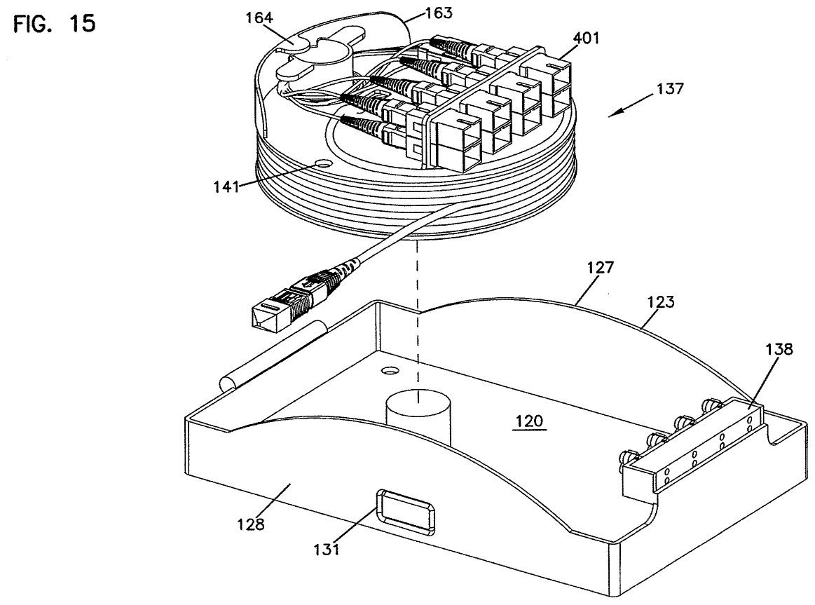

Referring now to FIGS. 8-18, an alternate embodiment of a fiber optic enclosure 121 is shown. The fiber optic enclosure 121 includes a housing 123 and a hinged cover 125.

The housing 123 includes a base wall 120, a first sidewall 127 and an oppositely disposed second sidewall 128. The first and second sidewalls 127, 128 extend outwardly from the base wall 120 such that the base wall 120 and the first and second sidewalls 127, 128 cooperatively define an interior region 130.

In the subject embodiment, the first sidewall 127 of the housing 123 defines a first port 131 while the second sidewall 128 defines a second port 132. The subscriber cable 122 enters/exits the fiber optic enclosure 121 at the first port 131 or at the second port 132. In the subject embodiment, both of the first and second ports 131, 132 are provided as knockout portions.

A cable spool 137 is positioned within the interior region 130 of enclosure 121. In the subject embodiment, the cable spool 137 is adapted for rotation within the interior region 130 of the enclosure 121. In the subject embodiment, the cable spool 137 includes a first axial end 136, an oppositely disposed second axial end 138 and a spool portion 139. The spool portion 139 is disposed between the first and second axial ends 136, 138 of the cable spool 137. The spool portion 139 is adapted to receive a subscriber cable 122 coiled around or spooled on the spool portion 139.

With the subscriber cable 122 spooled on the spool portion 139, the subscriber cable 122 can be selectively paid out by rotating the cable spool 137. As the cable spool 137 is rotated, the subscriber cable 122 is unwound from the spool portion 139 of the cable spool 137. After a desired length of subscriber cable 122 has been paid out, pin openings 141 can be used with a pin to fix the position of cable spool 137 relative to housing 123.

The subscriber cable 122 is shown with a connectorized end 144 (e.g., MTP connector) for connecting to the fiber distribution hub 17 or other equipment. An opposite end of the subscriber cable 122 passes through an opening 145 disposed in the first axial end 136 of the cable spool 137. After passing through the opening 145, the subscriber cable 122 is routed to a fanout 147 disposed on the first axial end 136 of the cable spool 137 where the cable is broken out into individual fibers 124 having connectorized ends 146 (e.g., SC connectors).

A cable management spool 161 is also disposed on the first axial end 136 of the cable spool 137. The cable management spool 161 manages fibers 124. In the subject embodiment, the cable management spool 161 includes a plurality of fingers 162 disposed on an end of the cable management spool 161. The fingers 162 assist with cable retention.

The first axial end 136 of the cable spool 137 further includes an outer guide wall 163. In the subject embodiment, the outer guide wall 163 is disposed at a portion of the peripheral edge of the first axial end 136 adjacent to the cable management spool 161. In the subject embodiment, the outer guide wall 163 extends outwardly in a direction that is generally perpendicular to the first axial end 136.

The outer guide wall 163 includes with a cable finger 164 disposed at an end of the outer guide wall 163 that is opposite the end engaged with the first axial end 136 of the cable spool 137. The cable finger 164 assists with retention and protection of the fibers 124.

An adapter plate 149 is disposed on the first axial end 136 of the cable spool 137. In the subject embodiment, the adapter plate 149 includes separate openings 151. Each of the separate openings 151 is adapted to receive two adapters 401.

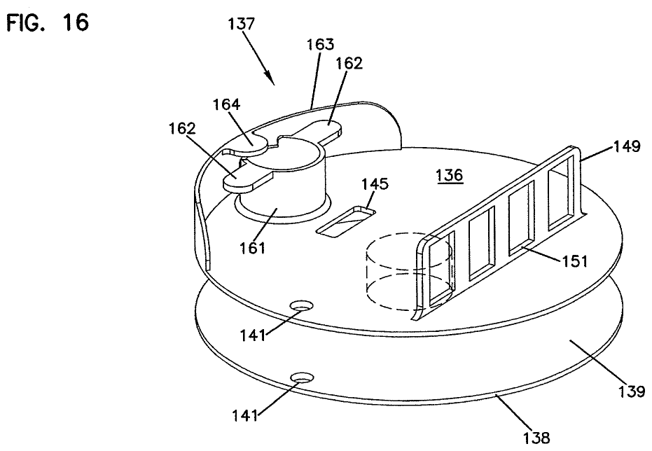

In the depicted embodiment of FIG. 16, the cable management spool 161, the outer guide wall 163 and the adapter plate 149 are integrally formed with the first axial end 136 of the cable spool 137. In the subject embodiment, the first axial end 136 of the cable spool 137 is formed from plastic. In another embodiment, the first and second axial ends 136, 138, the spool portion 139, the adapter plate 149, the cable management spool 161 and the outer guide wall 163 are integrally formed from a plastic material.

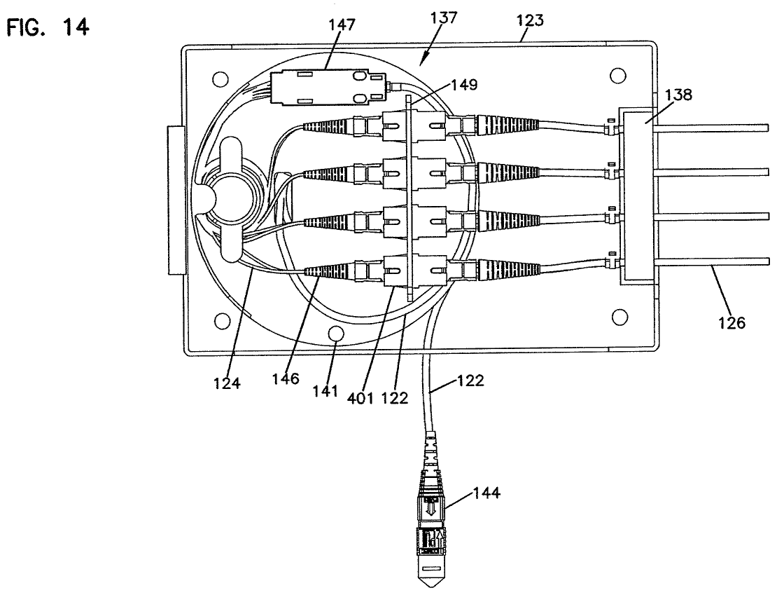

Referring now to FIGS. 13 and 14, the fiber optic enclosure 121 is shown connected to a second subscriber cable 126. After the subscriber cable 122 is paid out and cable spool 137 fixed in position relative to the housing 123, individual connectorized ends of the second subscriber cables 126 can be connected to the fibers 124 at adapters 401 of adapter plate 149. The second subscriber cables 126 exit the fiber optic enclosure 121 at a port 136 in a side 165 of the housing 123. In the illustrated embodiment, a slotted foam member 138 is disposed in the port 136. The slotted foam member 138 includes a plurality of slots through which the second subscriber cables 126 can be inserted in order to prevent or reduce the risk of ingress of environmental contamination (e.g., dust, water, etc.).

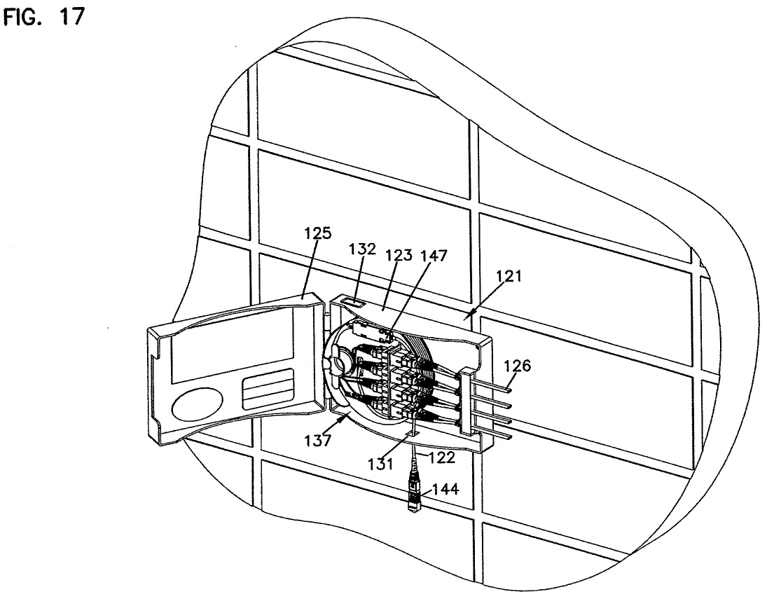

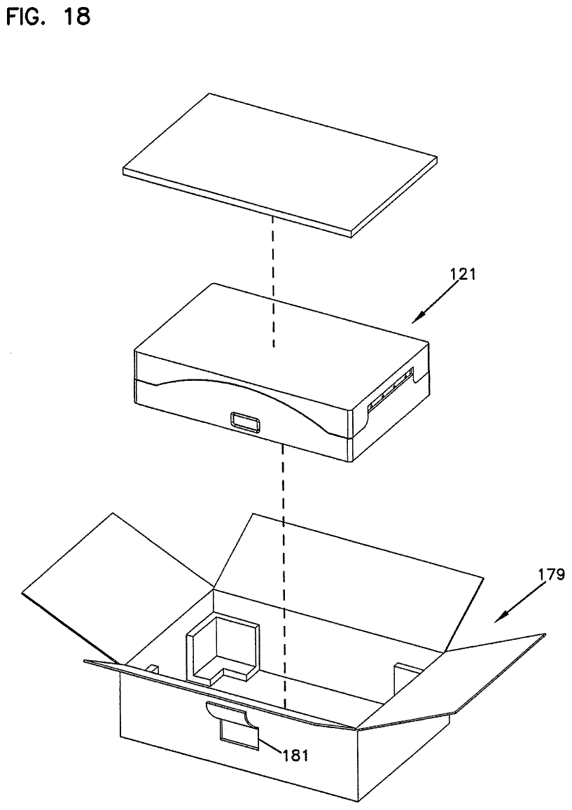

While the fiber optic enclosure 121 is shown mounted to a mounting location 183 (e.g., wall, pole, etc.) in FIGS. 1 and 17, it will be understood that the subscriber cable 122 can be paid out from the fiber optic enclosure 121 while the fiber optic enclosure 121 is either mounted to a mounting location 183 or removed from the mounting location 183. As shown in FIG. 18, the subscriber cable 122 could be paid out while the fiber optic enclosure 121 is still packaged in a shipping container 179 provided there is an opening 181 in the shipping container 179 through which the subscriber cable 122 can be pulled. After the subscriber cable 122 has been paid out, the fiber optic enclosure 121 can be removed from the shipping container 179 and mounted to the mounting location 183.

Various modifications and alterations of this disclosure will become apparent to those skilled in the art without departing from the scope and spirit of this disclosure, and it should be understood that the inventive scope of this disclosure is not to be unduly limited to the illustrative embodiments set forth herein.

1-20. (canceled)

21. A fiber optic enclosure comprising:
a housing including a base arrangement and a front cover that hingedly attaches to the base arrangement, the base arrangement being configured to be attached to a wall, the base arrangement including a base wall and sidewalls that project forwardly from the base wall, the sidewalls including first and second opposite sidewalls, the sidewalls also including third and fourth opposite sidewalls that extend between the first and second opposite side walls, the front cover being pivotal relative to the base arrangement about a pivot axis between a closed position and an open position;
the housing defining a cable opening for routing a subscriber cable into the housing;
a spool mounted within an interior of the base arrangement, the spool having a front end and a rear end;
a fiber optic cable adapted to be coiled about a spooling portion of the spool, the fiber optic cable including at least one optical fiber having a fiber end portion;
a fiber optic adapter positioned within the housing, the fiber optic adapter including a first connector port for receiving the fiber end portion and also including an opposite second connector port, the front cover preventing the first and second connector ports of the fiber optic adapter from being accessed from a front of the housing when the front cover is in the closed position, and the first and second connector ports of the fiber optic adapter being accessible from the front of the housing when the front cover is in the open position;
the spool being rotatable relative to the base arrangement about an axis of rotation, the fiber end portion being securable at the front end of the spool to allow the fiber end portion to rotate in concert with the spool when the spool is rotated about the axis of rotation relative to the base arrangement; and
wherein access for plugging a connectorized end of the subscriber cable into the second connector port of the fiber optic adapter is:
a) available from the front of the housing when the front cover is in the open position; and
b) not available from the front of the housing when the front cover is in the closed position.

22. The fiber optic enclosure of claim 21, further comprising a cable routing path for routing the subscriber cable to the second connector port of the fiber optic adapter, the cable routing path extending within the housing from the cable opening to the second connector port of the fiber optic adapter.

23. The fiber optic enclosure of claim 21, wherein the pivot axis is transversely oriented with respect to the axis of rotation, and wherein the axis of rotation intersects the front cover when the front cover is in the closed position and does not intersect the front cover when the front cover is in the open position.

24. The fiber optic enclosure of claim 23, wherein the pivot axis is located at the first sidewall and wherein the cable opening is defined at the third sidewall.

25. The fiber optic enclosure of claim 21, wherein the optic adapter is aligned along an orientation that is transverse with respect to the axis of rotation.

26. The fiber optic enclosure of claim 21, wherein the cable opening is defined at one of the sidewalls and includes a cable seal.

27. The fiber optic enclosure of claim 21, wherein the fiber end portion is connectorized.

28. The fiber optic enclosure of claim 27, wherein the fiber optic adapter rotates in concert with the spool when the spool is rotated about the axis of rotation.

29. A fiber optic enclosure comprising:
a housing including a base arrangement and a front cover that hingedly attaches to the base arrangement, the base arrangement being configured to be attached to a wall, the base arrangement including a base wall and sidewalls that project forwardly from the base wall, the sidewalls including first and second opposite sidewalls, the sidewalls also including third and fourth opposite sidewalls that extend between the first and second opposite side walls, the front cover being pivotal relative to the base arrangement about a pivot axis between a closed position and an open position;
a cable spool mounted within an interior of the base arrangement, the cable spool being rotatable relative to the base arrangement about a rotation axis that is transverse to the pivot axis, the cable spool including a spooling portion located between front and rear ends of the cable spool;
a fiber optic cable adapted to be coiled about the spooling portion of the cable spool, the fiber optic cable including at least one optical fiber having a fiber end portion;
the fiber end portion being securable at the front end of the cable spool to allow the fiber end portion to rotate in unison with the cable spool when the cable spool rotates about the rotation axis;
a fiber optic adapter mounted at a location in front of the cable spool, the fiber optic adapter including a first connector port for receiving the fiber end portion and also including an opposite second connector port; and
the front cover extending across the fiber optic adapter when disposed in the closed position.

30. The fiber optic enclosure of claim 29, wherein the sidewalls are devoid of openings suitable for mounting the fiber optic adapter.

31. The fiber optic enclosure of claim 29, wherein the housing defines a cable opening.

32. The fiber optic enclosure of claim 31, wherein a cable seal is disposed at the cable opening.

33. The fiber optic enclosure of claim 31, wherein the pivot axis is located at the first sidewall and wherein the cable opening is defined at the third sidewall.

34. The fiber optic enclosure of claim 31, wherein the optic adapter is aligned along an orientation that is transverse with respect to the axis of rotation.

35. The fiber optic enclosure of claim 34, further comprising a cable routing path for routing a subscriber cable to the second connector port of the fiber optic adapter, the cable routing path extending within the housing from the cable opening to the second connector port of the fiber optic adapter.

36. The fiber optic enclosure of claim 29, wherein the pivot axis is transversely oriented with respect to the axis of rotation, and wherein the axis of rotation intersects the front cover when the front cover is in the closed position and does not intersect the front cover when the front cover is in the open position.

37. The fiber optic enclosure of claim 29, wherein the base wall defines a plurality of rear fastener openings for use in attaching the housing to the wall.

38. The fiber optic enclosure of claim 29, wherein the fiber optic adapter rotates in concert with the cable spool when the cable spool is rotated about the axis of rotation, and wherein the fiber end portion is connectorized.

39. A fiber optic enclosure comprising:
a housing including a base arrangement and a front cover, the base arrangement being configured to be attached to a wall, the base arrangement including a base wall and sidewalls that project forwardly from the base wall, the sidewalls including first and second opposite sidewalls, the sidewalls also including third and fourth opposite sidewalls that extend between the first and second opposite side walls, the front cover being movable relative to the base arrangement to open and close front access to an interior of the base arrangement;
a cable spool mounted within the interior of the base arrangement for storing excess cable length within the housing, the cable spool being rotatable relative to the base arrangement about a rotation axis that is transverse relative to the base wall, the cable spool including a spooling portion located between front and rear ends of the cable spool;
a fiber optic connection region positioned in front of the cable spool, the fiber optic connection region including a fiber optic adapter including a first connector port and an opposite second connector port, the fiber connection region including a cable guide arrangement including at least one cable finger, the cable guide arrangement being configured for guiding a cable about at least a portion of a perimeter of the fiber optic connection region;
the front cover extending across the fiber optic adapter when front access to the interior of the base arrangement is closed; and
at least one of the side walls defining a cable pass-through location through which a subscriber cable can be routed.

40. The fiber optic enclosure of claim 39, wherein a cable seal is disposed at the cable pass-through location.

41. The fiber optic enclosure of claim 39, wherein the optic adapter is aligned along an orientation that is transverse with respect to the axis of rotation.

42. The fiber optic enclosure of claim 39, further comprising a cable routing path for routing a subscriber cable to the second connector port of the fiber optic adapter, the cable routing path extending within the housing from the cable opening to the second connector port of the fiber optic adapter.

43. The fiber optic enclosure of claim 39, wherein front cover is pivotally connected to the base arrangement, and pivotally moveable relative to the base arrangement about a pivot axis, wherein the pivot axis is transversely oriented with respect to the axis of rotation, and wherein the axis of rotation intersects the front cover when the front cover is in the closed position and does not intersect the front cover when the front cover is in the open position, wherein the pivot axis is located at the first sidewall and wherein the cable opening is defined at the third sidewall.

44. The fiber optic enclosure of claim 39, wherein the base wall defines a plurality of rear fastener openings for use in attaching the housing to the wall.

45. The fiber optic enclosure of claim 39, wherein the fiber optic adapter rotates in concert with the cable spool when the cable spool is rotated about the axis of rotation.
